(19) United States
(12) Patent Application Publication
(10) Pub. No.: US 2025/0284862 A1
(43) Pub. Date: Sep. 11, 2025

(54) ENABLING UNSTRUCTURED GRIDS FROM DEPOSITIONAL SPACE FOR FINITE ELEMENT SIMULATIONS

(71) Applicant: Schlumberger Technology Corporation, Sugar Land, TX (US)

(72) Inventors: Igor Shovkun, Menlo Park, CA (US); Karsten Fischer, Aachen (DE)

(21) Appl. No.: 18/598,127

(22) Filed: Mar. 7, 2024

(51) Int. Cl. G06F 30/23; G06F 111/10

(52) U.S. Cl. CPC G06F 30/23; G06F 2111/10

(57) ABSTRACT

A method includes receiving an unstructured grid including a plurality of cells. The method also includes eliminating a second face of a first cell in response to determining that the first and second faces are duplicates. The method also includes merging two or more of the faces of the first cell. The method also includes eliminating a hanging vertex of the first cell. The method also includes merging the first cell with a second cell. The method also includes collapsing an edge from at least one of the cells. The method also includes removing an unconnected face from at least one of the cells. The method also includes collapsing a thin face from at least one of the cells. The method also includes inflating at least one of the cells by moving a vertex of the cell to eliminate a concavity of the cell.

### BACKGROUND

Numerical simulation of the subsurface may be used to help understand processes governing hydrocarbon reservoirs and to predict fluid flow patterns and the rock mechanical response to operations. Reservoir simulators operate by solving partial differential equations discretized on a grid that describes the portion of the subsurface to be mathematically modelled. A reservoir simulation uses finite difference (FD), finite volume (FV), or finite element (FE) discretization. FD is used with structured grids, whereas FV and FE discretizations work also with unstructured grids.

Gridding algorithms have evolved substantially over the last 30 years. Driven by the demand to capture geological conditions in terms of geometrical structure and rock property distributions most accurately, unstructured grids are created from the depositional space. These so-called “depogrids” allow for creating polyhedral grids that conform to the depositional environment. It has proved itself commercially and is widely used in creating grids for FV modeling of fluid flow in subsurface reservoirs. Other numerical methods, however, such as the FE, frequently used in simulations that couple fluid flow to mechanics, cannot utilize these grids directly due to certain grid limitations.

The standard finite element method FEM can discretize several elementary polyhedral types. An extension of FEM, the polyhedral finite element method (PFEM), was created to solve PDE on arbitrary star-convex polyhedral. It was further demonstrated to be able to discretize mechanical systems with fractures. Applying PFEM to depogrids still presents challenges, as some grid cells are not start-convex, contain very short edges, contain very thin faces, and/or are degenerate. Additionally, depogrids contain a large number of vertices that do not improve the quality of discretization but increase the computational cost of the simulation.

### SUMMARY

A method for repairing an unstructured grid is disclosed. The method includes receiving the unstructured grid including a plurality of cells. The method also includes eliminating a hanging vertex of one of the cells. The method also includes inflating one of the cells by moving a non-hanging vertex of the cell to eliminate a concavity of the cell.

A computing system is also disclosed. The computing system includes one or more processors and a memory system. The memory system includes one or more non-transitory computer-readable media storing instructions that, when executed by at least one of the one or more processors, cause the computing system to perform operations. The operations include receiving an unstructured grid. The unstructured grid includes a plurality of cells. A first of the cells includes a plurality of faces including a first face and a second face. The operations also include eliminating the second face in response to determining that the first and second faces are duplicates. The operations also include merging two or more of the faces of the first cell. The two or more faces are merged after the second face is eliminated. The operations also include eliminating a hanging vertex of the first cell. The hanging vertex is eliminated after the two or more faces are merged. The operations also include merging the first cell with a second cell to produce a new cell. The first and second cells are merged after the hanging vertex is eliminated. The operations also include collapsing an edge from at least one of the cells. The operations also include removing an unconnected face from at least one of the cells. The operations also include collapsing a thin face from at least one of the cells. The operations also include inflating at least one of the cells by moving a vertex of the cell to eliminate a concavity of the cell.

A non-transitory computer-readable medium is also disclosed. The medium stores instructions that, when executed by one or more processors of a computing system, cause the computing system to perform operations. The operations include receiving an unstructured grid. The unstructured grid includes a plurality of cells. A first of the cells includes a plurality of faces including a first face and a second face. The operations also include repairing the unstructured grid to produce a modified unstructured grid. The unstructured grid is repaired while substantially preserving an overall structure described by the unstructured grid and the cells therein, a number of the cells in the unstructured grid, and volumes of the cells in the unstructured grid. Repairing the unstructured grid includes eliminating the second face in response to determining that the first and second faces are duplicates. Repairing the unstructured grid also includes merging two or more of the faces of the first cell. The two or more faces are merged after the second face is eliminated. The two or more faces are merged while substantially preserving a shape of the first cell. Repairing the unstructured grid also includes eliminating a hanging vertex of the first cell. The hanging vertex is eliminated after the two or more faces are merged. The vertex is hanging in response to a number of the faces of the first cell that contain the vertex being less than three. Repairing the unstructured grid also includes merging the first cell with a second cell to produce a new cell. The first and second cells are merged after the hanging vertex is eliminated. An interface between the first and second cells is larger than an interface between the first and any other one of the cells. Repairing the unstructured grid also includes collapsing an edge from at least one of the cells. The edge is collapsed from the new cell. The edge is collapsed in response to determining that the edge has a length that is at least 50 times less than a size of the cell in a direction tangent to the edge. Repairing the unstructured grid also includes removing an unconnected face from at least one of the cells. The unconnected face is removed from the new cell. The unconnected face is removed after the edge is collapsed. The unconnected face does not share any edges with any other faces of the unstructured grid. Repairing the unstructured grid also includes collapsing a thin face from at least one of the cells. The thin face is collapsed from the new cell. The thin face is collapsed after the unconnected face is removed. A ratio of a length to a width of the thin face is greater than 25:1. Repairing the unstructured grid also includes inflating at least one of the cells. The cell that is inflated is the new cell. The cell is inflated by moving a vertex of the cell to eliminate a concavity of the cell. The operations also include performing a numerical simulation of a subsurface discretized by the modified unstructured grid.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates a flowchart of a method for repairing an unstructured grid, according to an embodiment.

FIG. 3 illustrates merging two or more faces of a cell, according to an embodiment.

FIG. 4 illustrates eliminating of a hanging vertex from a cell, according to an embodiment.

FIGS. 5A-5D illustrate distorted or degenerate cells, according to an embodiment.

FIG. 6 illustrates collapsing of a (e.g., short) edge of a cell, according to an embodiment.

FIG. 7 illustrates collapsing a thin face of a cell, according to an embodiment.

FIG. 8 illustrates inflating a concave cell, according to an embodiment.

FIG. 9 illustrates splitting a cell to retain a level of discretization of a fault, according to an embodiment.

FIG. 10 illustrates a schematic view of the repair procedure, according to an embodiment.

FIGS. 11A and 11B illustrate the before and after of the repair of a grid including nine cells, according to an embodiment.

FIGS. 12A and 12B illustrate the before and after of the repair of a grid with a single fault, according to an embodiment.

FIGS. 13A and 13B illustrate the before and after of the repair of a grid, according to an embodiment.

FIG. 14 illustrates a schematic view of a computing system for performing at least a portion of the method(s) described herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. It will, however, be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

### System Overview

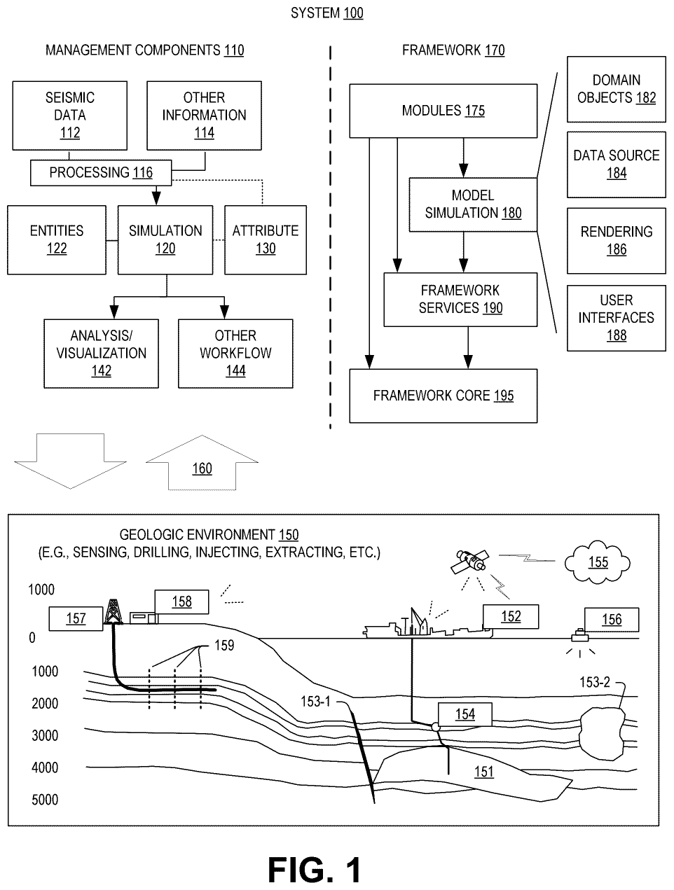

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT®.NET® framework (Redmond, Washington), which provides a set of extensible object classes. In the NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (SLB, Houston Texas), the INTERSECT™ reservoir simulator (SLB, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (SLB, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (SLB, Houston, Texas) allows for integration of add-ons (or plug-ins) into a PETREL® framework workflow. The OCEAN® framework environment leverages .NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

Modification Algorithm for Enabling Unstructured Grids from Depositional Space for Finite Element Simulations

The present disclosure is an algorithmic procedure for resolving the issues outlined above. Generally speaking, the procedure is not limited to depogrids, but can be applied to “clean” any grids used for PFEM simulations. More particularly, the procedure may repair unstructured grids in order to enable them for finite element simulations. The procedure may accomplish this by applying a series of (e.g., nine) repairs to the grid. Each of these repairs selects a target group of elements (e.g., cells, faces, and/or edges) for application, and then performs a single operation (e.g., merge, elimination, etc.) to the selected entities. This series of repairs may repeat some of the repair steps. At the same time, each step may perform a single type of transformation to the grid (e.g., as opposed to fusing them).

The proposed repair procedure may include sequentially applying the following (e.g., nine) procedures to a depogrid:
eliminating duplicate cell faces
merging faces
eliminating hanging vertices
merging degenerate cells
collapsing short edges
removing unconnected faces
collapsing thin faces
inflating concave cells
splitting fracture tips

The criterion of a successful repair strategy is the ability to construct PFEM basis functions for each cell of the grid. This includes (i) an invertibility of the discretization of a Laplace problem on the subgrid of a grid cell and/or (ii) a positive transformation Jacobian between a reference element and the current grid cell.

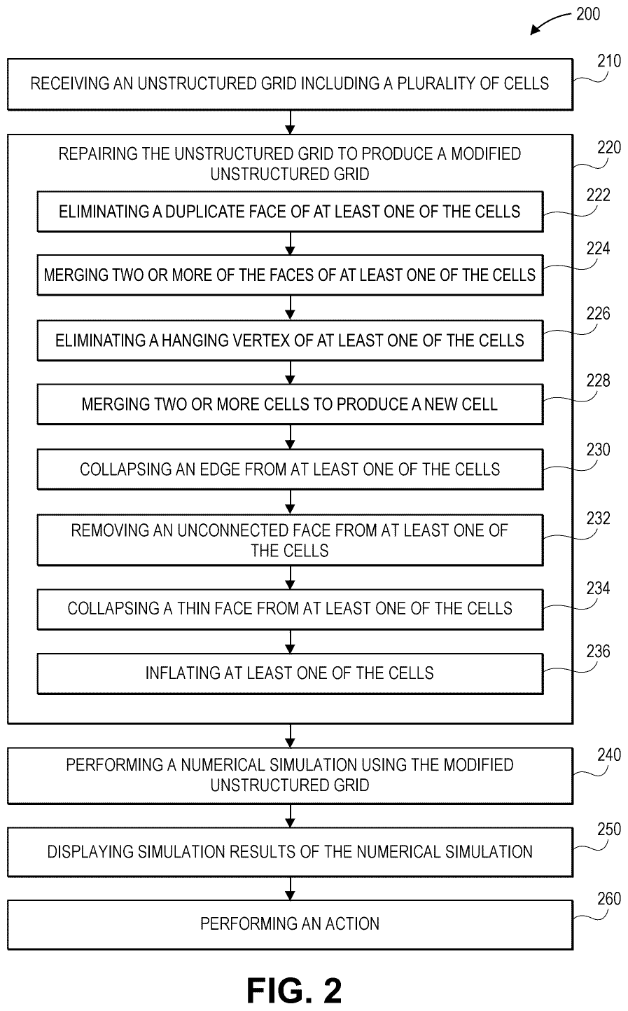

FIG. 2 illustrates a flowchart of a method 200 for repairing an unstructured grid, according to an embodiment. An illustrative order of the method 200 is provided below; however, one or more portions of the method 200 may be performed in a different order, simultaneously, repeated, or omitted. At least a portion of the method 200 may be performed by a computing system (described below).

The method 200 may include receiving an unstructured grid, as at 210. The unstructured grid may include a plurality of cells. One or more of the cells (e.g., a first cell) may include a plurality of faces including at least a first face and a second face.

The method 200 may also include repairing the unstructured grid to produce a repaired (also referred to as modified) unstructured grid, as at 220. The unstructured grid may be repaired while substantially preserving an overall structure described by the unstructured grid and the cells therein, a number of the cells in the unstructured grid, volumes of the cells in the unstructured grid, or a combination thereof. As used herein, “substantially preserving” refers to (1) preserving more than 98% of the original volume of the structure, (2) preserving more than 95% of the area of labeled feature surfaces such as faults, horizons, and exterior boundaries, and/or (3) preserving the shape of the interior/exterior surfaces such that the deviation of any point within the repaired surface is 10% or less than the square root of the area of the surface.

### Eliminating Duplicate Faces

Repairing the unstructured grid may include eliminating duplicate faces of a cell in the unstructured grid, as at 222. For example, this may include eliminating the second face of the first cell in response to determining that the first and second faces are duplicates.

In an example, the cells in the unstructured grid can be defined with a list of their faces. More particularly, a first cell may be specified by four unique faces [1, 4, 6, 8], and a second cell may be specified by [6, 6, 8, 10, 14]. The numbers designate the ids (indices) of faces. In this particular example, the duplicate cell face elimination procedure may not affect the first cell but will replace the second cell with a third/new cell specified by filtered list of unique faces of the second cell: [6, 8, 10, 14].

### Merging Faces

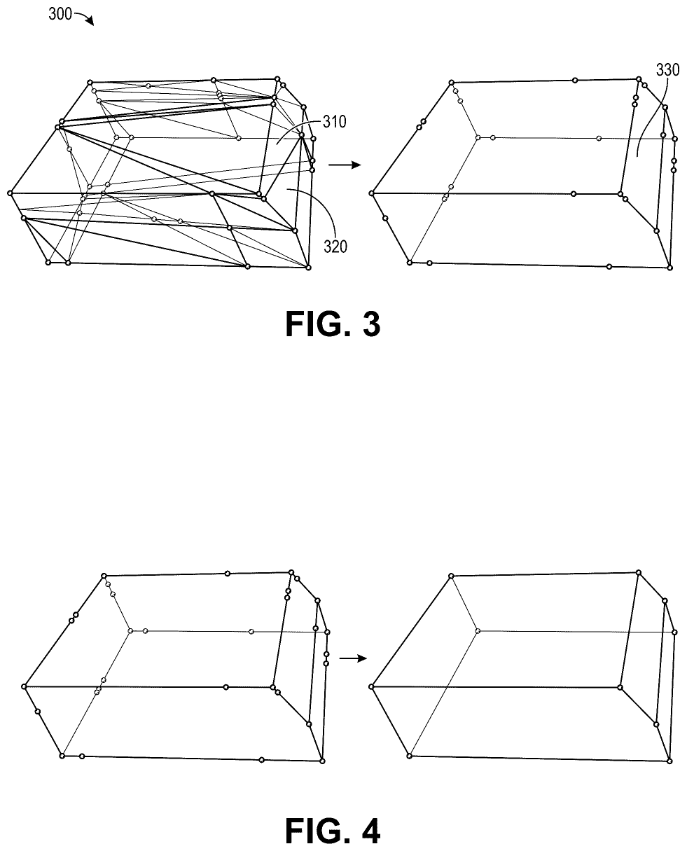

Repairing the unstructured grid may also include merging two or more of the faces of a cell in the unstructured grid, as at 224. FIG. 3 illustrates the merging of faces 310, 320 of a cell (e.g., the first cell) 300, according to an embodiment. The two or more faces 310, 320 may be merged (e.g., to produce a single face 330) after the second face is eliminated. The two or more faces 310, 320 may be merged while substantially preserving a shape of the first cell 300. The two or more faces 310, 320 may be merged in response to determining that:
(i) the two or more faces 310, 320 are in contact with one another such that the two or more faces 310, 320 are neighbors; and
(ii) the two or more faces 310, 320 share a same marker (e.g., an external boundary or a fault); or
(iii) the two or more faces 310, 320 are elements to a same set of the cells.

### Eliminating Hanging Vertices

Repairing the unstructured grid may also include eliminating a hanging vertex of a cell in the unstructured grid, as at 226. A vertex may be considered hanging in response to a number of the faces of the cell (i.e., the cell that contains the vertex) being less than three. FIG. 4 illustrates the elimination of a hanging vertex from a cell 400, according to an embodiment. The hanging vertices are shown as dots in FIG. 4. One or more of the hanging vertices may be eliminated after the two or more faces are merged. This elimination procedure removes the hanging vertices from the unstructured grid. A hanging vertex 1 that is shared by two edges that include vertices [1, 2] and [1, 3] can be eliminated by creating a new edge that includes vertices [2, 3] and the removal of the parent edges from the grid. In an embodiment, the vertices may not be removed if that would lead to cells with less than 4 faces.

### Merging Distorted/Degenerate Cells

Repairing the unstructured grid may also include merging two cells (e.g., the first cell and a second cell) to produce a (e.g., single) new cell, as at 228. The first and second cells may be merged after the hanging vertex is eliminated. An interface between the first and second cells may be larger than an interface between the first and any other cell in the unstructured grid. Polyhedral cells encountered in depogrids are sometimes distorted to the point that the construction of harmonic basis functions fails. The first and second cells may be merged in response to determining that the first cell is distorted or degenerate.

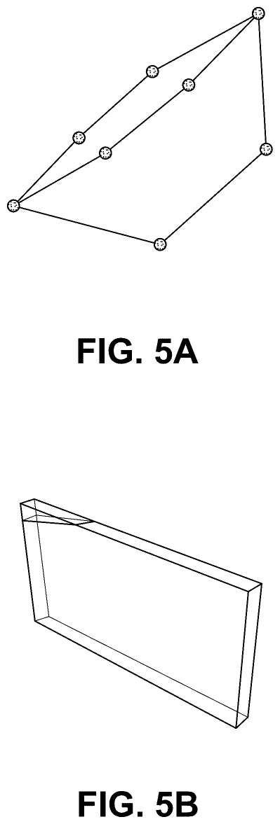

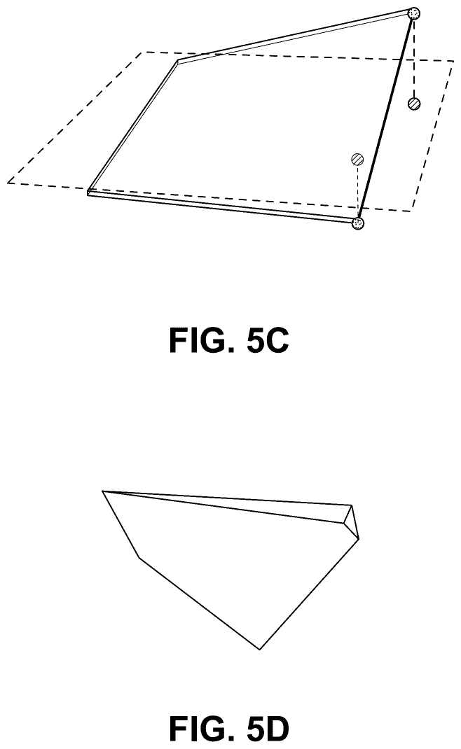

FIGS. 5A-5D illustrate distorted (also referred to as degenerate) cells, according to an embodiment. The first and second cells may be merged in response to determining that the first cell is distorted or degenerate such that the first cell has less than four faces (FIG. 5A). This may be referred to as a taco cell. The first and second cells may also or instead be merged in response to determining that the first cell is distorted or degenerate such that the first cell is at least 10 times, 20 times, 50 times, or 100 times smaller than any neighboring cell in any direction (FIG. 5B). The first and second cells may also or instead be merged in response to determining that the first cell is distorted or degenerate such that at least one of the faces of the first cell is bent more than 20%, more than 35%, or more than 50% of a thickness of the first cell (FIG. 5C). The first and second cells may also or instead be merged in response to determining that the first cell is distorted or degenerate such that the first cell is partially or fully collapsed such that it is flat (FIG. 5D). The first and second cells may also or instead be merged in response to determining that the first cell is distorted or degenerate such that the first cell has one or more holes.

### Removing/Collapsing Short Edges

Repairing the unstructured grid may also include collapsing an edge from a cell in the unstructured grid, as at 230. The edge may be collapsed from the new cell. The edge may be collapsed in response to determining that the edge has a length that is at least 10 times, 20 times, 50 times, or 100 times less than a size of the cell (e.g., in a direction tangent to the edge).

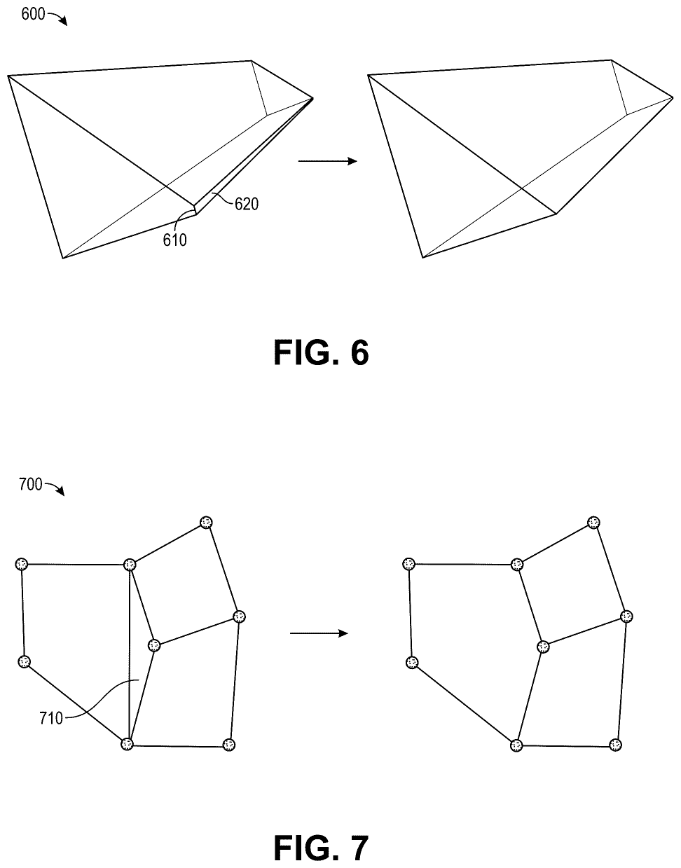

More particularly, some cells in depogrids contain short edges. A short edge may be defined as an edge that is smaller than a fraction of the cell size in the direction of the edge. Such edges may fail the construction of PFEM basis functions. Specifically, it may drive the transformation Jacobian to zero. Collapsing an edge defined by vertices [1, 2] may include replacing the vertex 2 with the vertex 1 in the lists of adjacent faces and cells. FIG. 6 illustrates the collapsing of a (e.g., short) edge 610 of the cell 600, according to an embodiment. In the example shown in FIG. 6, the elimination of a short edge 610 also caused collapse (less than 3 vertices) and/or elimination of a face 620.

### Removing Unconnected/Stale Faces

Repairing the unstructured grid may also include removing an unconnected face (also referred to as a stale face) from a cell in the unstructured grid, as at 232. The unconnected face may be removed from the new cell. The unconnected face may be removed after the edge is collapsed. The unconnected face may be removed by removing it from the list of cell faces and the list of the grid faces. The unconnected face may not share any edges with any other faces of the unstructured grid. The unconnected face may not contribute to a volume of its cell. The unconnected face may cause the mapping Jacobian to be zero.

### Collapsing/Squashing Thin Faces

Repairing the unstructured grid may also include squashing or collapsing a thin face from a cell in the unstructured grid, as at 234. The thin face may be collapsed from the new cell. The thin face may be collapsed after the unconnected face is removed. The thin face may be collapsed by (i) identifying the folding point, where the angle between the adjacent edges is <5 degrees, (ii) sorting the vertices of the thin face by distance from the folding point and forming a series of edges that connect every contiguous pair of sorted vertices, (iii) identifying old edges that are not present in the newly-created series of edges, and (iv) replacing the previously-identified old edges with the sub-series of edges create in step (ii). The thin face may have a length that is larger than its width. For example, a ratio of a length to a width of the thin face may be greater than 10:1, 25:1, or 50:1. FIG. 7 illustrates the collapsing of a thin face 710 of a cell 700, according to an embodiment. The presence of the thin face 710 may cause the transformation Jacobian to be close to zero.

### Inflating Concave Cells

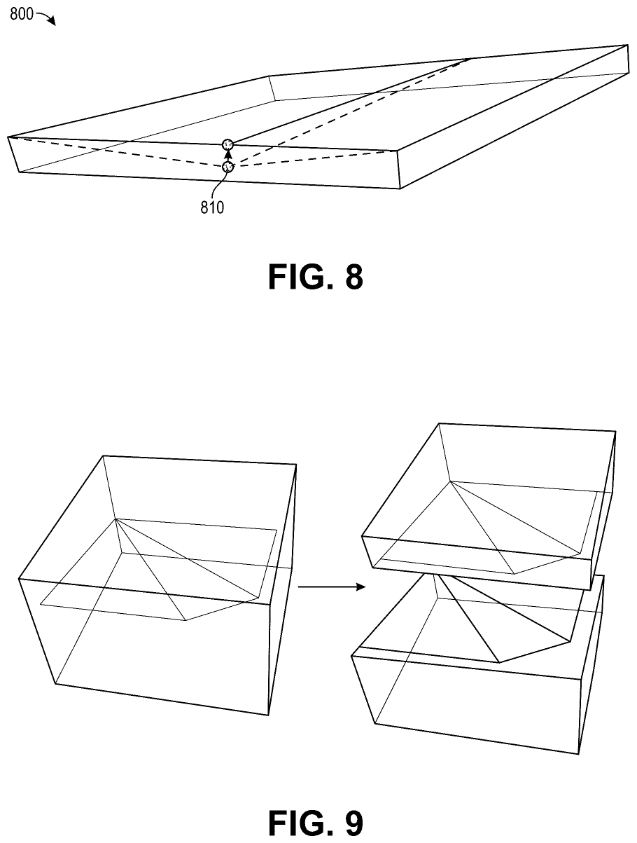

Repairing the unstructured grid may also include inflating a cell in the unstructured grid, as at 236. The cell that is inflated may be the new cell. The cell may be inflated by moving a (e.g., non-hanging) vertex of the cell to eliminate a concavity of the cell. FIG. 8 illustrates inflation of a concave cell 800, according to an embodiment. The arrow illustrates a vertex 810 being moved up to eliminate the concavity. Although PFEM involves cells to be start-convex, the mapping procedure that is used for optimization may fail when the transformation Jacobian is negative. The inflating repair may be employed to remedy this.

### Splitting Fracture Tips

In depogrids, grid cells that host fracture tips may be inherently concave. Instead of inflating these cells, however, a cell splitting strategy may be employed to retain the level of discretization of the fault. This procedure is exemplified in FIG. 9.

After the unstructured grid is repaired to produce the modified unstructured grid, the method 200 may also include performing a numerical simulation using the modified unstructured grid, as at 240. For example, the numerical simulation may be performed on a subsurface discretized by the modified unstructured grid. The numerical simulation may also or instead be performed to model the deformation of aircrafts (e.g., spaceships), buildings, the flow of plasma, etc.

The method 200 may also include displaying simulation results of the numerical simulation, as at 250. The simulation results may be displayed in a 3D modeling platform.

The method 200 may also include performing an action, as at 260. The action may be performed in response to repairing the unstructured grid and/or the simulation results. The action may be or include guiding operation decision making (e.g., at a wellsite) such as selecting where to drill a wellbore. The action may also or instead include generating or transmitting a signal that instructs or causes a physical action to occur (e.g., at the wellsite). The action may also be or include performing the physical action (e.g., at the wellsite). The physical action may include drilling the wellbore, varying a weight and/or torque on a drill bit that is drilling the wellbore, varying a drilling trajectory of the wellbore, varying a concentration and/or flow rate of a fluid pumped into the wellbore, or the like.

### Overall Algorithm

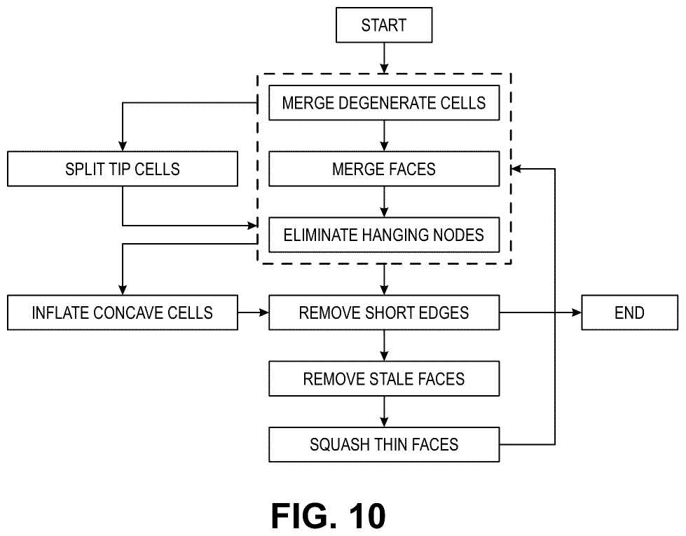

FIG. 10 illustrates a schematic view of the repair procedure, according to an embodiment. FIG. 10 is similar to FIG. 2, except the order has been modified. In this embodiment, the blocks “Merge Degenerate Cells” (228)—“Merge Faces” (224)—“Eliminate Hanging Nodes” (226) may repeat multiple times (e.g., three times) throughout the procedure. This block of repairs allows for the elimination of degenerate cells that might (1) be initially present in the grid, (2) appear after splitting tip cells, and/or (3) appear upon inflating, squashing, or eliminating faces.

### Example 1: Nine Grid Cells Near a Horizon-Fault Junction

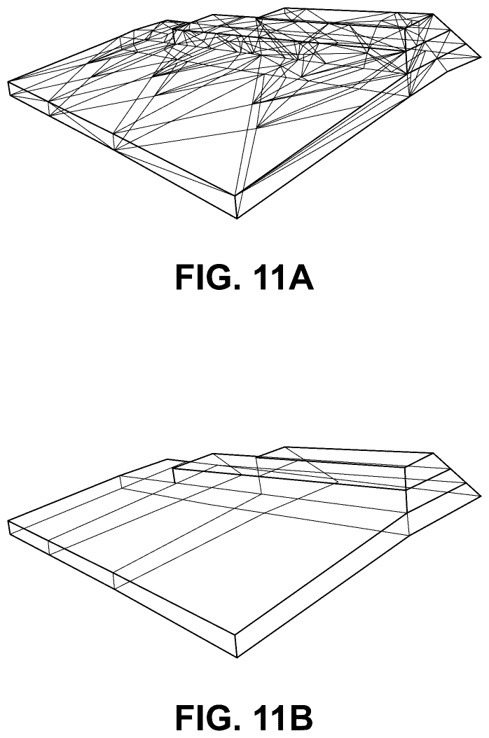

FIGS. 11A and 11B illustrate the before (FIG. 11A) and after (FIG. 11B) of the repair of a grid including nine cells, according to an embodiment. This example helps to visualize the full set of transformation that a grid undergoes during the repair procedure. Before the repairs (FIG. 11A), the grid may include nine cells with many faces, small edges, and vertices. After the repairs (FIG. 11B), nine hexahedra may be seen that have the shape very similar to that before the repair. The numbers of faces and vertices, however, have decreased substantially.

### Example 2: Full Grid with a Single Fault

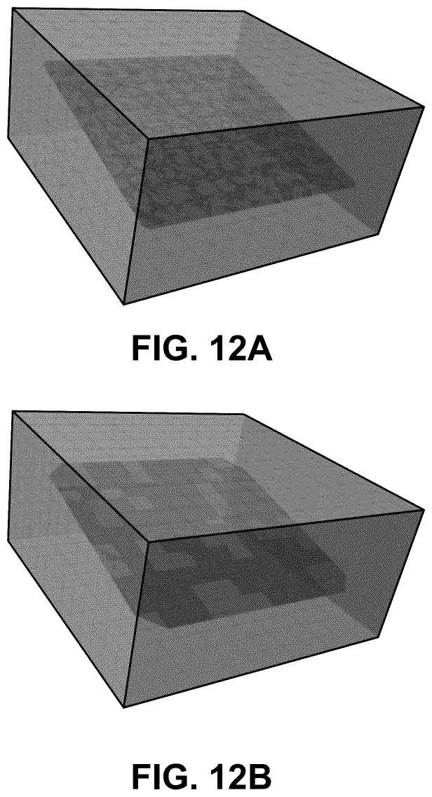

FIGS. 12A and 12B illustrate the before (FIG. 12A) and after (FIG. 12B) of the repair of a grid with a single fault in a subsurface, according to an embodiment. The exterior boundary faces of the original grid (FIG. 12A) are triangles, whereas those of the post-repairs grid (FIG. 12B) are quadrangles. The changes in the numbers of cells, vertices, and faces are listed in Table 1. The number of vertices and faces decreased after the repairs, which is beneficial for nodal-based FE computations. The number of grid cells increased slightly during the repairs. This is due to the fact that there were no degenerate cell merges performed, whereas the number of cells increased due to splitting tip cells.

TABLE 1
The change in the numbers of grid entities as a result of repairs

| Parameter | Before repairs | After repairs |
|---|---|---|
| Number of cells | 1,798 | 1,844 |
| Number of vertices | 20,000 | 2,500 |
| Number of faces | 59,000 | 6,000 |

### Example 3: Thrust-Fold Grid

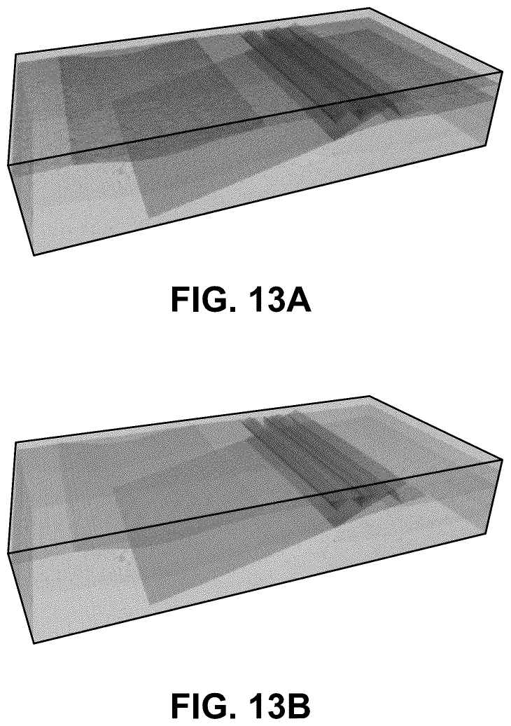

FIGS. 13A and 13B illustrate the before (FIG. 13A) and after (FIG. 13B) of the repair of a grid, according to an embodiment. This example illustrates the application of the procedure to a relatively large case (e.g., 960 k cells). The grid features five horizons and eight faults. The changes in the number of cells, faces, and vertices upon the repairs are listed in Table 2. In contrast to the previous example, the number of cells decreased slightly. This is due to merging degenerate cells. As in the previous example, the numbers of vertices and faces decreased substantially. The changes in the exterior structure of the grid is depicted in FIGS. 13A and 13B. It may be seen that the exterior faces were triangular before the repairs (FIG. 13A) and are mostly quadrangles after the repairs (FIG. 13B).

TABLE 2
The number of thrust-fold grid entities before
(left) and after (right) the repairs.

| Number of | Before repairs | After repairs |
|---|---|---|
| Cells, 10³ | 960 | 959 |
| Vertices, 10³ | 1,733 | 1,033 |
| Faces, 10³ | 7,844 | 2,949 |

### INDUSTRY PERSPECTIVE

Finite-element-based simulations on unstructured grids become prevalent in reservoir engineering, CFD, and mechanics communities. While physics-modeling capabilities meet the client requests, conventional methods lack the capability of generating high-quality grids for finite element simulations. Thus, the ability to use the same unstructured grids with arbitrary polyhedral for (potentially fully-coupled) FV and FE simulations may improve conventional technologies.

### CONCLUSION

The present disclosure provides a grid repair strategy that is capable of making depogrids feasible for finite element simulations. The reference implementation of the methodology has been demonstrated to repair commercial scale grids. Additional benefits of the repair strategy include the reduced number of nodal degrees-of-freedom and the absence of concave cells that negatively affect the quality of FV solutions.

### Exemplary Computing System

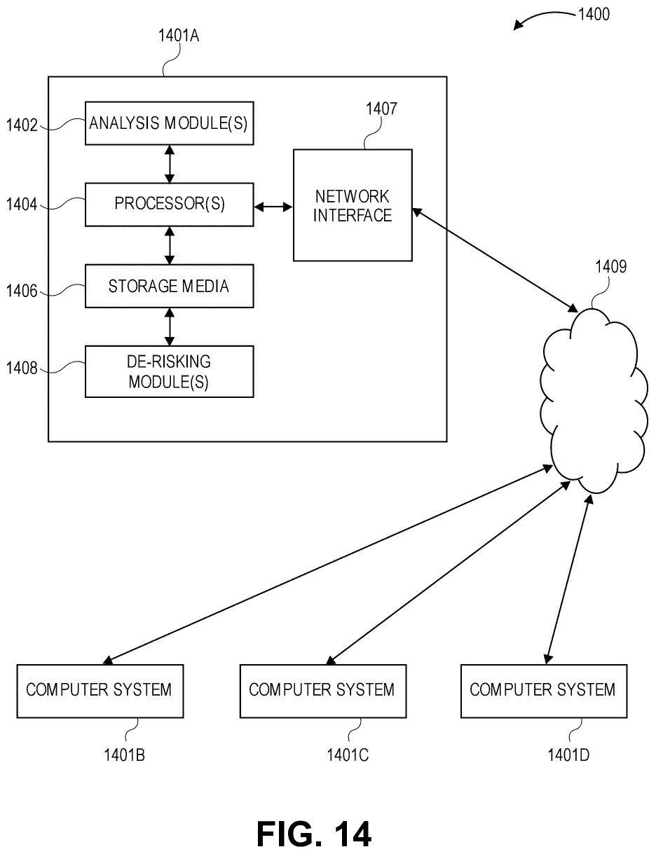

In some embodiments, the methods of the present disclosure may be executed by a computing system. FIG. 14 illustrates an example of such a computing system 1400, in accordance with some embodiments. The computing system 1400 may include a computer or computer system 1401A, which may be an individual computer system 1401A or an arrangement of distributed computer systems. The computer system 1401A includes one or more analysis modules 1402 that are configured to perform various tasks according to some embodiments, such as one or more methods disclosed herein. To perform these various tasks, the analysis module 1402 executes independently, or in coordination with, one or more processors 1404, which is (or are) connected to one or more storage media 1406. The processor(s) 1404 is (or are) also connected to a network interface 1407 to allow the computer system 1401A to communicate over a data network 1409 with one or more additional computer systems and/or computing systems, such as 1401B, 1401C, and/or 1401D (note that computer systems 1401B, 1401C and/or 1401D may or may not share the same architecture as computer system 1401A, and may be located in different physical locations, e.g., computer systems 1401A and 1401B may be located in a processing facility, while in communication with one or more computer systems such as 1401C and/or 1401D that are located in one or more data centers, and/or located in varying countries on different continents).

A processor may include a microprocessor, microcontroller, processor module or subsystem, programmable integrated circuit, programmable gate array, or another control or computing device.

The storage media 1406 may be implemented as one or more computer-readable or machine-readable storage media. Note that while in the example embodiment of FIG. 14 storage media 1406 is depicted as within computer system 1401A, in some embodiments, storage media 1406 may be distributed within and/or across multiple internal and/or external enclosures of computing system 1401A and/or additional computing systems. Storage media 1406 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 1400 contains one or more grid repair module(s) 1408. In the example of computing system 1400, computer system 1401A includes the grid repair module 1408. In some embodiments, a single grid repair module may be used to perform some aspects of one or more embodiments of the methods disclosed herein. In other embodiments, a plurality of grid repair modules may be used to perform some aspects of methods herein.

It should be appreciated that computing system 1400 is merely one example of a computing system, and that computing system 1400 may have more or fewer components than shown, may combine additional components not depicted in the example embodiment of FIG. 14, and/or computing system 1400 may have a different configuration or arrangement of the components depicted in FIG. 14. The various components shown in FIG. 14 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 1400, FIG. 14), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrate and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method for repairing an unstructured grid, the method comprising:
receiving the unstructured grid comprising a plurality of cells;
eliminating a hanging vertex of one of the cells; and
inflating one of the cells, wherein the cell is inflated by moving a non-hanging vertex of the cell to eliminate a concavity of the cell.

2. The method of claim 1, wherein the vertex is hanging in response to a number of faces of the cell that contain the vertex being less than three.

3. The method of claim 1, wherein one of the cells comprises a plurality of faces including a first face and a second face, and wherein the method further comprises eliminating the second face of the cell in response to determining that the first and second faces are duplicates.

4. The method of claim 1, further comprising merging two or more faces of one of the cells, wherein the two or more faces are merged while substantially preserving a shape of the first cell.

5. The method of claim 4, wherein the hanging vertex is eliminated after the two or more faces are merged.

6. The method of claim 1, further comprising merging two of the cells to produce a new cell, wherein the two cells are merged after the hanging vertex is eliminated.

7. The method of claim 6, wherein the cell that is inflated is the new cell.

8. The method of claim 1, further comprising collapsing an edge from at least one of the cells.

9. The method of claim 1, further comprising removing an unconnected face from at least one of the cells, wherein the unconnected face does not share any edges with any other faces of the unstructured grid, and wherein the unconnected face does not contribute to a volume of its cell.

10. The method of claim 1, further comprising collapsing a thin face from at least one of the cells.

11. A computing system, comprising:
one or more processors; and
a memory system comprising one or more non-transitory computer-readable media storing instructions that, when executed by at least one of the one or more processors, cause the computing system to perform operations, the operations comprising:
receiving an unstructured grid, wherein the unstructured grid comprises a plurality of cells, and wherein a first of the cells comprises a plurality of faces including a first face and a second face;
eliminating the second face in response to determining that the first and second faces are duplicates;
merging two or more of the faces of the first cell, wherein the two or more faces are merged after the second face is eliminated;
eliminating a hanging vertex of the first cell, wherein the hanging vertex is eliminated after the two or more faces are merged;
merging the first cell with a second cell to produce a new cell, wherein the first and second cells are merged after the hanging vertex is eliminated;
collapsing an edge from at least one of the cells;
removing an unconnected face from at least one of the cells;
collapsing a thin face from at least one of the cells; and
inflating at least one of the cells, and wherein the cell is inflated by moving a vertex of the cell to eliminate a concavity of the cell.

12. The computing system of claim 11, wherein the vertex is hanging in response to a number of the faces of the first cell that contain the vertex being less than three.

13. The computing system of claim 11, wherein an interface between the first and second cells is larger than an interface between the first and any other one of the cells.

14. The computing system of claim 11, wherein the edge is collapsed in response to determining that the edge has a length that is at least 50 times less than a size of the cell in a direction tangent to the edge.

15. The computing system of claim 11, wherein the thin face is collapsed after the unconnected face is removed, and wherein a ratio of a length to a width of the thin face is greater than 25:1.

16. A non-transitory computer-readable medium storing instructions that, when executed by one or more processors of a computing system, cause the computing system to perform operations, the operations comprising:
receiving an unstructured grid, wherein the unstructured grid comprises a plurality of cells, and wherein a first of the cells comprises a plurality of faces including a first face and a second face;
repairing the unstructured grid to produce a modified unstructured grid, wherein the unstructured grid is repaired while substantially preserving an overall structure described by the unstructured grid and the cells therein, a number of the cells in the unstructured grid, and volumes of the cells in the unstructured grid, and wherein repairing the unstructured grid comprises:
eliminating the second face in response to determining that the first and second faces are duplicates;
merging two or more of the faces of the first cell, wherein the two or more faces are merged after the second face is eliminated, wherein the two or more faces are merged while substantially preserving a shape of the first cell;
eliminating a hanging vertex of the first cell, wherein the hanging vertex is eliminated after the two or more faces are merged, and wherein the vertex is hanging in response to a number of the faces of the first cell that contain the vertex being less than three;
merging the first cell with a second cell to produce a new cell, wherein the first and second cells are merged after the hanging vertex is eliminated, wherein an interface between the first and second cells is larger than an interface between the first and any other one of the cells;
collapsing an edge from at least one of the cells, wherein the edge is collapsed from the new cell, and wherein the edge is collapsed in response to determining that the edge has a length that is at least 50 times less than a size of the cell in a direction tangent to the edge;
removing an unconnected face from at least one of the cells, wherein the unconnected face is removed from the new cell, wherein the unconnected face is removed after the edge is collapsed, and wherein the unconnected face does not share any edges with any other faces of the unstructured grid;
collapsing a thin face from at least one of the cells, wherein the thin face is collapsed from the new cell, wherein the thin face is collapsed after the unconnected face is removed, and wherein a ratio of a length to a width of the thin face is greater than 25:1; and
inflating at least one of the cells, wherein the cell that is inflated is the new cell, and wherein the cell is inflated by moving a vertex of the cell to eliminate a concavity of the cell; and
performing a numerical simulation of a subsurface discretized by the modified unstructured grid.

17. The non-transitory computer-readable medium of claim 16, wherein the two or more faces are merged in response to determining that:
(i) the two or more faces are in contact with one another such that the two or more faces are neighbors; and
(ii) the two or more faces share a same marker, wherein the marker comprises an external boundary or a fault; or
(iii) the two or more faces are elements to a same set of the cells.

18. The non-transitory computer-readable medium of claim 16, wherein the first and second cells are merged in response to determining that the first cell is distorted or degenerate such that:
(i) the first cell has less than four faces;
(ii) the first cell is at least 50 times smaller than any neighboring cell in any direction;
(iii) at least one of the faces of the first cell is bent more than 35% of a thickness of the first cell;
(iv) the first cell has holes; or
(v) the first cell is partially collapsed.

19. The non-transitory computer-readable medium of claim 16, wherein the operations further comprise displaying simulation results of the numerical simulation in a 3D modeling platform.

20. The non-transitory computer-readable medium of claim 16, wherein the operations further comprise generating or transmitting a signal that causes an action to occur at a wellsite in response to the simulation results.
